(19) United States
(12) Patent Application Publication
(10) Pub. No.: US 2014/0332534 A1
(43) Pub. Date: Nov. 13, 2014

(54) Disposable Splatter Shield

(71) Applicant: Michael F. Nason, Pukalani, HI (US)

(72) Inventor: Michael F. Nason, Pukalani, HI (US)

(21) Appl. No.: 14/275,881

(22) Filed: May 13, 2014

Related U.S. Application Data
(60) Provisional application No. 61/822,896, filed on May 13, 2013.

(51) Int. Cl. A47J 36/06

(52) U.S. Cl. CPC A47J 36/06
USPC 220/369

(57) ABSTRACT

A disposable splatter shield includes a sheet of material having an array of holes arranged in a pattern to allow gas vapor to pass through the holes while blocking the splatter of liquid droplets from passing through the holes. The sheet of material is shaped to cover various cooking containers and includes a raised portion around the periphery of the sheet for placement over the edges of a pan. Tabs formed in the outer periphery of the sheet can be angularly lifted from the plane of the sheet to allow the handle of the cooking container to fit therein.

### CROSS-REFERENCE TO RELATED APPLICATIONS

This application claims the benefit of U.S. Provisional Patent Application No. 61/822,896 titled “Disposable Splatter Shield,” filed May 13, 2013, incorporated herein by reference.

### BACKGROUND OF THE INVENTION

1. Field of the Invention

The invention relates to covers or lids for use on cooking containers such as pans and further relates to disposable products. The invention more specifically relates to splatter shields for use with frying pans and similar cooking utensils.

2. Description of Related Art

Conventional splatter shields are expensive. As oil gets burned or coated onto these shields, they become sticky, unsanitary and difficult to clean. It is desirable to provide a convenient, cost effective disposable splatter shield. The present invention provides embodiments of such a shield.

### SUMMARY OF THE INVENTION

It is an object of the present invention to provide embodiments of a disposable splatter shield for use in cooking so as to minimize and contain the splattering of food and grease.

This and other objects will be apparent based on the disclosure herein.

The present invention is a disposable splatter shield that includes a sheet of material having an array of holes arranged in a pattern to allow gas vapor to pass through the holes while blocking the splatter of liquid droplets from passing through the holes. The sheet of material is shaped to cover various cooking containers such as a pan or a griddle. A lip (also referred to herein as a plateau) can be included around the periphery of the sheet such that the lip can be placed over the edges of a pan. The invention can be shaped for use with other types of cooking utensils. Some embodiments of the invention include one or more tabs formed in the outer periphery of the sheet. The tab can be angularly lifted from the plane of the sheet to allow the handle of the cooking container to fit therein. Alternately, the tabs can be formed elsewhere as needed, such as in the lip. In some embodiments, the present invention can be constructed from a paper product such as molded pulp fiber o paperboard or alternately can be constructed from tin foil. These materials are examples only. Based on the teachings herein, those skilled in the art will recognize other materials suitable for use in the present invention. The shield is suitable for use on a stovetop, in a conventional oven and in a microwave oven.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a top view of an embodiment of the present invention.

FIG. 2 shows an oblique view of the embodiment of FIG. 1.

FIG. 3 shows a side view of the embodiment of FIG. 1.

### DETAILED DESCRIPTION OF THE INVENTION

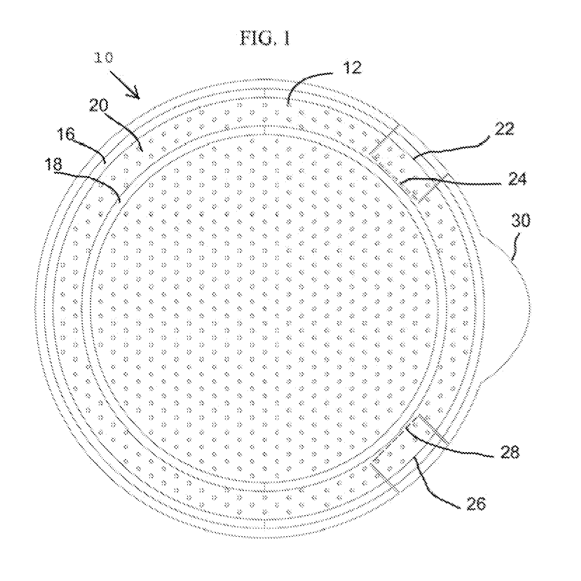

FIG. 1 shows a top view of an embodiment of the present invention. The disposable shield 10 includes an array of holes 12 that are small enough in diameter to prevent the passage of liquid droplets yet allow gas flow. A raised area is located along the periphery. The raised area includes a wall 16 and a wall 18. A plateau area 20 is located at the top edge of each wall and Connects them together. The plateau area also includes the array of holes. The shield further includes a first tab 22 having a bendable edge 24 and a second tab 26 having a bendable edge 28. A handle 30 is provided so a user can control of the position and placement of the shield. The user can position the shield on a pan so that the tab is desirably placed and one of the tabs can be placed over a handle of the pan.

The material of the shield is chosen to be inexpensive and therefore disposable. A non-exclusive list of such material includes paper products such as (i) molded pulp fiber (ii) paperboard and (iii) tin foil. Tin foil has the benefit of being generally non-absorbent of cooking by-products. It should be understood that this is but one embodiment and other embodiments will be apparent to those skilled in the art based upon the teachings herein. For example, the disposable shield can take other forms such as, e.g., a square or a rectangle, and may not include any one or more of (i) the tabs, (ii) the raised area or (iii) the handle. The configuration of holes can take any pattern such as a regular, evenly spaced configuration or can be randomly placed.

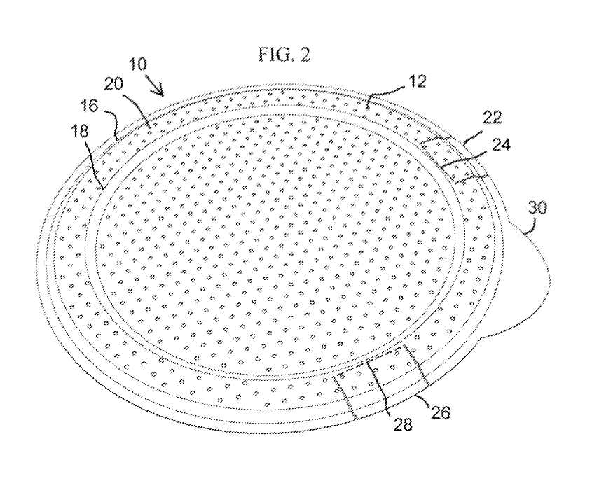

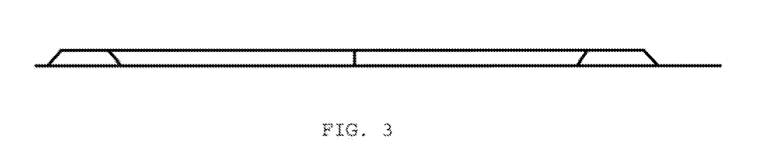

FIG. 2 shows an oblique view of the embodiment of FIG. 1 and includes the disposable shield 10 having the array of holes 12 and the raised area having walls 16 and 18 and plateau area 20. The figure further shows the first tab 22, the bendable edge 24, the second tab 26, the bendable edge 28 and the handle 30. FIG. 3 shows a side view of the embodiment of FIG. 1.

The foregoing description of the invention has been presented for purposes of illustration and description and is not intended to be exhaustive or to limit the invention to the precise form disclosed. Many modifications and variations are possible in light of the above, teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. A disposable splatter shield, comprising:
a body of material having an outer periphery configured to rest on the rim of a cooking utensil, wherein said body of material includes a plurality of through holes and further includes at least one tab formed by a pair of slits that extends from a central portion of said body to said outer periphery, wherein said at least one tab can be angularly lifted from the plane of said body.

2. The disposable splatter shield of claim 1, wherein said through holes are small enough in diameter to prevent the passage of liquid droplets yet large enough to allow gas to flow through said holes.

3. The disposable splatter shield of claim 1, further comprising a handle fixedly connected to said outer periphery so a user can control said body.

4. The disposable splatter shield of claim 1, wherein said body of material comprises molded pulp fiber.

5. The disposable splatter shield of claim 1, wherein said body of material comprises paperboard.

6. The disposable splatter shield of claim 1, wherein said body of material comprises tin foil.

7. The disposable splatter shield of claim 1, wherein said holes are configured as an array in said body.

8. The disposable splatter shield of claim 1, wherein said holes are evenly spaced one from another in said body.

9. The disposable splatter shield of claim 1, wherein said holes are regularly spaced from one another in said body.

10. The disposable splatter shield of claim 1, wherein said holes are randomly spaced in said body.

11. The disposable splatter shield of claim 1, further comprising a raised area Located along said periphery and configured so that said rim will fit therein.

12. The disposable splatter shield of claim 11, wherein said raised area includes a first wall and a second all and further includes a plateau area that connects the top edge o said first wall to the top edge of said second wall.

13. The disposable splatter shield of claim 12, wherein said plateau area includes said holes.

14. The disposable splatter shield of claim 1, wherein said body of material comprises a shape selected from the group consisting of a circle, an ellipse, a triangle, a square and a rectangle.

15. The disposable splatter shield of claim 1, wherein said material is substantially non-absorbent of said liquid droplets and said gas.

16. The disposable splatter shield of claim 1, wherein said body comprises a sheet of said material.

17. An apparatus, comprising:
a shoot of material having an array of holes arranged in it pattern to allow gas vapor to pass through the holes while blocking the splatter of liquid droplets from passing through the holes, wherein said sheet of material is shaped to cover a cooking container, wherein said sheet of material includes a lip around the periphery of said sheet such that said lip can be placed over the edges of said cooking container, wherein said sheet further comprises at least one tab formed in the outer periphery of said sheet, wherein said at least one tab can be angularly lifted from the plane of the sheet to allow the handle of said cooking container to fit therein.

18. The apparatus of claim 17, wherein said body of material is formed of a material selected from the group consisting of molded pulp fiber, paperboard and tin foil.

19. The apparatus of claim 17, further comprising a raised area located along said periphery and configured so that said rim will fit therein, wherein said raised area includes a first wall and a second wall and further includes a plateau area that connects the top edge of said first wall to the top edge of said second wall.

20. The apparatus of claim 17, wherein said material is substantially non-absorbent of said liquid droplets and said gas.
